(19) United States
(12) Patent Application Publication
(10) Pub. No.: US 2015/0204374 A1
(43) Pub. Date: Jul. 23, 2015

(54) RATCHET NUT AND WASHER

(71) Applicant: Zeb Stewart, Brooklyn, NY (US)

(72) Inventor: Zeb Stewart, Brooklyn, NY (US)

(21) Appl. No.: 14/158,168

(22) Filed: Jan. 17, 2014

(51) Int. Cl. F16B 39/12

(52) U.S. Cl. CPC F16B 39/12

(57) ABSTRACT

A fastening system which includes a bolt, a washer with at least one protrusion on one surface and at least one tooth on the other surface, and a nut with at least one tooth on a surface are provided. The teeth on the surfaces of the nut and washer are configured to drive the protrusion into an object, and also prevent the nut from backing off of the bolt. The fastening system can include a plurality of teeth on the surface of the nut and washer that form ratcheted surfaces, where the ratcheted surface of the nut and the ratcheted surface of the washer are inverted with each other. The fastening system can also include a plurality of protrusions located on a surface of the washer that are configured to be driven into an object.

### FILED OF THE INVENTION

The present invention is directed to fastening devices typically used to secure a bolt to one or more objects.

### BACKGROUND OF THE INVENTION

Generally, after a bolt is inserted into an object, a nut may be threaded onto the bolt at the end opposing the head of the bolt in order to secure the bolt within the object. Optionally, a washer may be slid onto the bolt after it is inserted into the object and prior to threading the nut onto the bolt so as to evenly distribute pressure of the nut over the object, and to provide a smooth surface for the nut to bear on. Often, a washer is also slid onto the bolt prior to the insertion of the bolt into the object for similar reasons. This fastening system is well-known in the art.

Alternatively, a bolt may be screwed directly into an object such that the end of the bolt opposing the bolt head does not protrude from the object. This bolt may include a bolt head that is configured to allow the bolt to be gripped by the head of the bolt, and tightened by turning the bolt. Optionally, a washer may be slid onto the bolt prior to screwing the bolt into the object. This fastening system is well-known in the art.

However, a conventional nut and bolt configuration is subject to loosening. Loosening can occur when the nut and bolt configuration is subject to a vibration load, or temperature and humidity fluctuations. This results in a “backing off” of the nut, where the nut rotates towards the end of the bolt, which loosens the bolt. If the nut is removed completely from the bolt, the entire bolt may become completely detached from the object. Thus, an improved nut, washer, and bolt configuration is needed.

### SUMMARY OF THE INVENTION

The fastening system of the present invention includes a bolt configuration that is convenient and easy to use, and yet is resistive to loosening under vibrational loads or fluctuations in temperature and humidity. For instance, with conventional bolt configurations, when the bolt configuration is subject to extreme loads or vibrational loads, this may cause the nut or bolt to loosen or “back off”. Additionally, changes in temperature and humidity may cause the object being fastened to change in dimension, which can result in a loosened configuration. This is particularly true with wood materials, which often go into production with a high moisture content, and may dry and contract in dimension over time.

The present invention can be used in a variety of applications and environments, such as, for example, military equipment, farm equipment, automotive and trucking applications, airplane applications, rail applications, weather-proofing building materials, and outdoor structure construction.

The fastening system includes a washer with at least one protrusion on one surface and at least one tooth on the other surface, and a washer engaging member, for instance a nut or a bolt head, with at least one tooth on a surface. The teeth on the washer engaging member and washer drive the protrusion into an object, and also prevent the washer engaging member from “backing off,” or loosening. In an embodiment, at least one tooth on the washer and the at least one tooth on the washer engaging member form ratcheted surfaces, where the ratcheted surfaces are inverted with respect to each other. The inverted ratcheted surfaces prevent the washer engaging member from “backing off” when locked together with the washer, thus creating a vibration-resistant system. In an embodiment, a plurality of protrusions are located on a surface of the washer, and are configured to be driven into an object. In an embodiment, the plurality of protrusions are of a sufficient length so that when the protrusions are driven into the object, the washer is locked in place. The protrusions penetrate into the object being fastened, and thus the bolt configuration will be unaffected by surface dimension changes, and remain locked.

### BRIEF DESCRIPTION OF THE DRAWINGS

FIG. 1 is a side view of an embodiment of the fastening system when in use.

FIG. 2A is a side view of the washer according to an embodiment of the fastening system.

FIG. 2B is a side view of the nut according to an embodiment of the fastening system.

FIG. 3 is a side view of the engaged nut and washer according to an embodiment of the fastening system.

FIGS. 4A-E are profile views of the various formations that the teeth of the washer and the nut may include.

FIG. 5 is a side view of the engaged bolt head and washer according to an embodiment of the fastening system when in use.

### DETAILED DESCRIPTION OF THE INVENTION

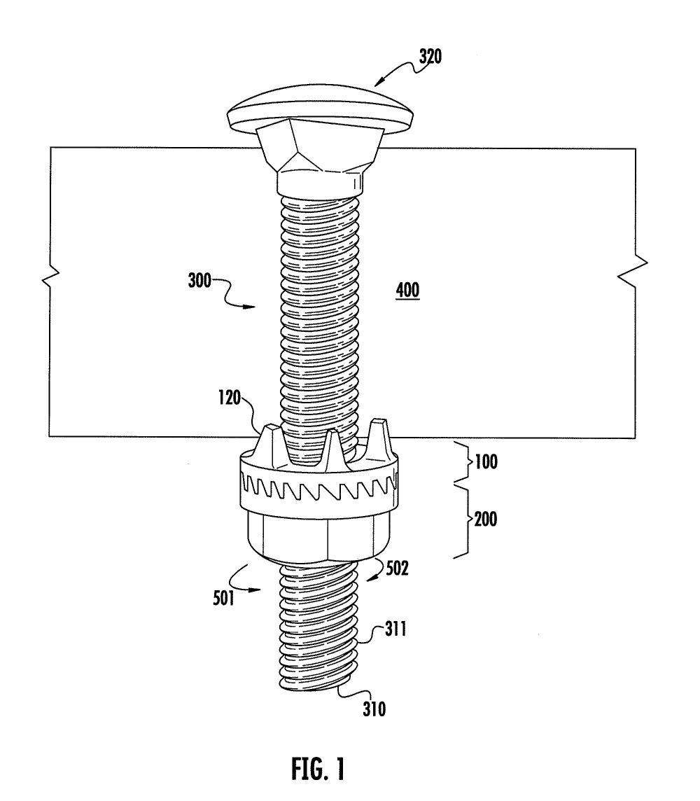

A fastening system generally can include a washer, a washer engaging member, and a bolt. Referring to FIG. 1, a fastening system includes a washer 100, a washer engaging member (nut 200), and a bolt 300. The bolt 300 includes a shaft 310 and a head 320, and shaft 310 is further threaded with thread 311. The nut 200 can be threadedly engaged with the bolt 300, and the washer 100 can be slid along the shaft 310 of the bolt 300. In an embodiment of the invention, the bolt 300 is configured to be inserted into a hole in one or more objects 400. The washer 100 is configured to be slid onto the shaft 310 of the bolt. The nut 200 is configured to be threaded onto the shaft 310 of the bolt. Much like conventional bolts, nuts, and washers, the bolt 300 is configured to be inserted into one or more objects 400, or a hole within an object, such that the head 320 is located on one end of the one or more objects 400, and the opposing end of the shaft 310 extends outwards from the other end of the one or more objects 400. The washer 100 is then configured to be slid along the opposing end of the shaft 310, and the nut 200 is configured to be threaded onto the opposing end of the shaft 310 so as to secure the bolt 300 within the one or more objects 400. Though FIG. 1 depicts only one object 400, it is understood by those skilled in the art that object 400 may include a plurality of objects 400 that are to be secured by the fastening system. It is further understood by those skilled in the art that the fastening system of the present invention may be used with conventional tools, such as any type of wrench, socket driver, or the like.

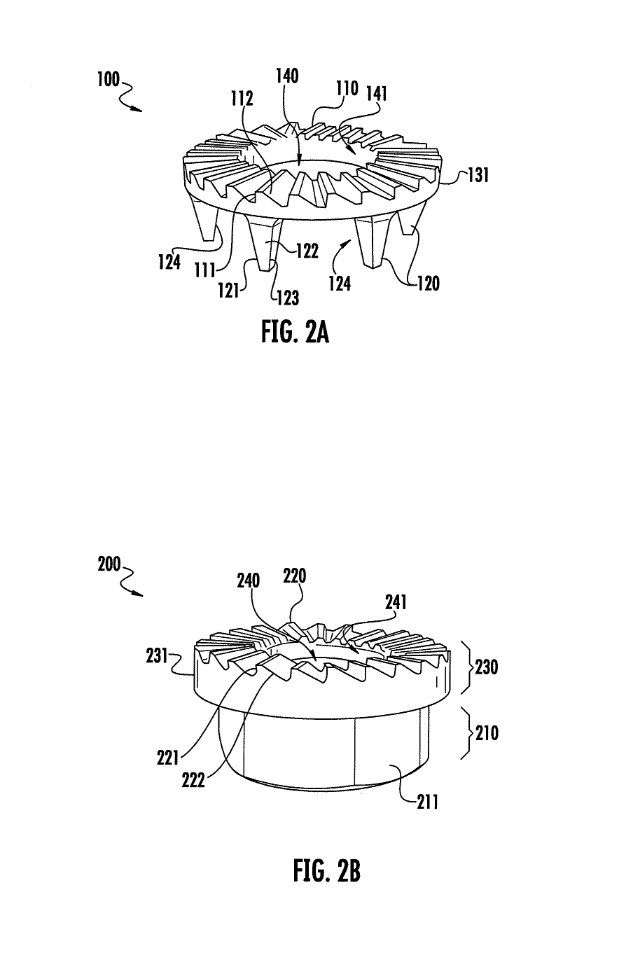

Referring to FIG. 2A, in an embodiment of the invention, the washer 100 has a cylindrical hole 140 around a central axis. The diameter of the hole 140 is larger than the diameter of the thread 311 on the shaft 310, and is smaller than the diameter of the head 320 of the bolt 300. The washer 100 further comprises an upper and lower surface, as well as an outer surface 131 and an inner surface 141. The lower surface comprises at least one protrusion 120, which extends from the lower surface of the washer 100. The protrusion 120 is configured so that it may penetrate the surface of the object 400. The protrusion 120 is of a sufficient length that when it penetrates the object 400, the washer is secured to the object 400. In an embodiment, the at least one protrusion 120 preferably is perpendicular to the lower surface of the washer, and includes a pointed end. The protrusion can further include two slanted side surfaces 121 and 123, and triangular front and back surfaces 122 and 124. The upper surface of the washer comprises at least one tooth 110. In an embodiment of the invention, the tooth 110 is an inclined tooth which further comprises an inclined surface 112 and a leading edge 111.

Referring to FIG. 2B, in an embodiment of the invention, the nut 200 has a cylindrical hole 240 around a central axis, and an outer surface 231. The cylindrical hole 240 is threaded with a thread 241 that is configured to be engaged with the thread 311 of the bolt 300. In an embodiment, the nut 200 further comprises a flange portion 230 and a tightening portion 210. The tightening portion can be similar to that of a conventional nut, and include flat surfaces 211 for a wrench to clamp onto. In an embodiment, the tightening portion 210 can include six flat surfaces 211 that form a hexagonal shape.

In an embodiment, the flange portion 230 can be located above the tightening portion 210. Preferably, the flange portion 230 has a greater diameter than the tightening portion 210. The flange portion 230 comprises an upper surface, which has at least one tooth 220. In an embodiment of the invention, the tooth 220 is an inclined tooth which further comprises an inclined surface 222 and a leading edge 221.

The teeth 220 of the nut 200 and the teeth 110 of the washer 100 are configured so that when the nut is turned in a first direction 501, the surface of the nut 200 engages with the surface of the washer 100 to force the washer 100 to move along the bolt while allowing the inclined surface 222 of the nut's teeth 220 to slide along the inclined surface 112 of the washer's teeth 110. By turning the nut 200 in the first direction, the washer 100 is moved by the nut 200 until the protrusions 120 penetrate the surface of the object 400. The washer 100 is then secured to the object 400 when the protrusions 120 are sufficiently inserted into the object 400, as is seen in FIG. 1. The movement of the nut 200 against the washer 100 when the nut 200 is turned in a first direction creates a linear hammering force that drives the washer 100 into the object 400. Thus, in an embodiment, the at least one tooth 110 on the washer and the at least one tooth 220 on the nut form ratcheted surfaces on the washer and the nut, which are configured to lock the washer and the nut together.

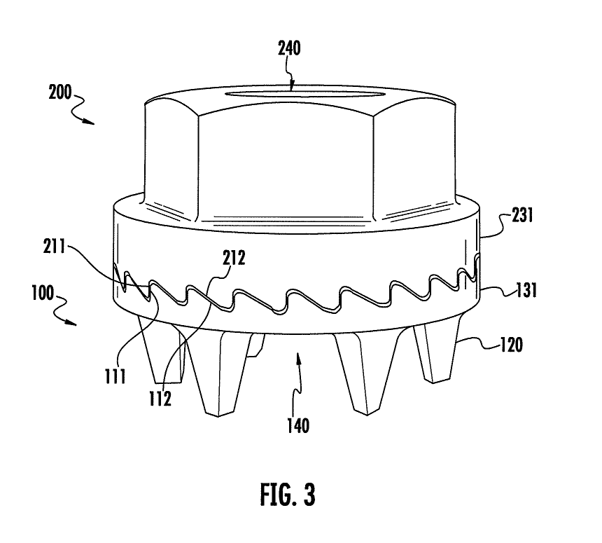

As shown in FIG. 3, the at least one tooth 110 of the washer and the at least one tooth 220 of the nut are configured such that they mate with each other so that there is substantially no gap between the nut and the washer. Preferably, when the nut and the washer engage with each other, the inclined surface 112 of the washer's teeth 110 will mate with the inclined surface 222 of the nut's teeth 220, and the leading edge 111 of the washer's teeth 110 will mate with the leading edge 221 of the nut's teeth 220. Because of this, when the nut 200 is turned in a second direction 502, if the protrusions 120 of the washer 100 are secured within the object 400, then the leading edge 221 of the nut's teeth 220 will meet the leading edge 111 of the washer's teeth 110, thereby preventing the nut from being turned in the second direction.

Thus, this ratcheting engagement of the surfaces of the nut and the washer allow for the nut 200 to be turned in a first direction 501, but not allow for the nut to turn in a second direction 502 opposite the first direction 501. Therefore, once the washer 100 is secured to the object 400 via the protrusions 120, the teeth 110 of the washer 100 are configured to maintain the nut 200 in a tightened position and prevent the nut 200 from “backing off” the bolt 300 over time, especially when the fastening system is subject to a load, vibrations, or other external conditions.

The fastening system of the present invention is capable of providing a permanent attachment of the object 400. However, if a permanent attachment is not desired, in an embodiment, the washer 100 may be formed to release when a certain amount of back force is applied. The washer 100 may include teeth 110 that are configured in a manner such that they may shear off when a certain threshold amount of back force is applied, leaving an approximately flat surface on the washer 100, and allowing the nut to be loosened. This can be accomplished by either selecting a material for the washer that is less resistant to shearing force, or selecting a smaller size of the teeth 110.

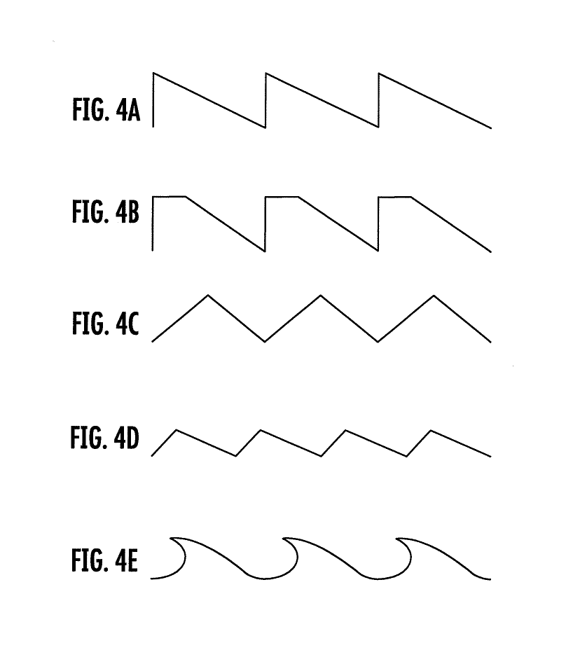

Referring to FIG. 4, the teeth 110 of the washer and the teeth 220 of the nut may be of any shape that allows for the washer and nut to engage each other while allowing movement of the nut in one direction relative to the washer. In FIG. 4A, a profile of the teeth 110 and 220 having an inclined surface and a leading edge is shown. Similarly, in FIG. 4B, a profile of the teeth 110 and 220 may have an incline surface and a leading edge, as well as an upper flat surface. As shown in FIGS. 4C-4D, the teeth of the washer may have two inclined surfaces. As shown in FIG. 4C, the teeth in this embodiment can be symmetrical, or as shown in FIG. 4D, the inclined surfaces may be of different lengths or pitch such that the teeth are asymmetrical. Alternatively, as shown in FIG. 4E, the teeth may have a wave shape. The shape of the teeth 110 and 220 are not limited to these embodiments, and can include variations on the profiles depicted in FIGS. 4A-4E.

Similarly, the at least one protrusion 120 may be of any shape capable of penetrating the surface of an object 400. It will be readily understood by one of skill in the art that the particular configuration of the protrusions 120 will be dependent on the material and configuration of the object to be secured. For example, if the object to be secured is made of wood, the protrusions are preferably pointed at their ends so that the protrusions are capable of penetrating the wood without pre-drilling the holes. Similarly, and for example, if the protrusions are intended to secure pre-cast metal objects together and those pre-cast metal objects have pre-drilled holes for accommodating the protrusions, then the protrusions can be made into a shape that corresponds to the pre-drilled holes. Moreover, the protrusion 120 may extend from the lower surface of the washer at an angle, the protrusion 120 may include a plurality of pointed ends, and/or the protrusion 120 may have a conical shape, a pyramid shape, a rhomboid shape, or a cylindrical shape.

It should be noted that while the figures show a cylindrical washer 100 with a cylindrical hole 140, the cross-section of the washer may be of any shape, and the cross-section of the cylindrical hole 140 may be of any shape. Similarly, the bolt need not be cylindrical in shape, and the tightening portion 210 and flange portion 230 of the nut may be of any shape.

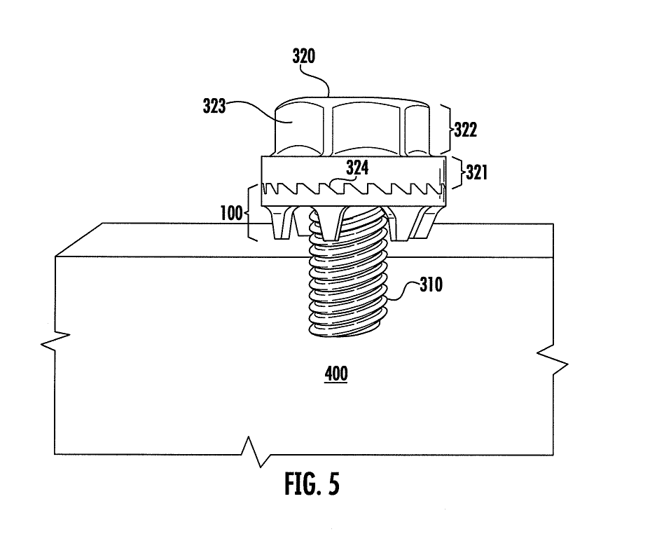

FIG. 5 shows a further embodiment of the present invention configured as a lag bolt, self-threading screw, etc., such that the washer engaging member includes the bolt head 320 itself and an attached threaded shaft 310. In this embodiment, the bolt may be inserted into and fastened to an object 400 with or without protruding through the object 400. The bolt head 320 may include a flange portion 321 and a tightening portion 322. The tightening portion can be similar to that of a conventional bolt head with tightening surfaces, and include flat surfaces 323 for a wrench to clamp onto. In an embodiment, the tightening portion 322 can include six flat surfaces 323 that form a hexagonal shape.

The flange portion 321 can include the features of the flange portion 230 of the nut, described above. For instance, the flange portion 321 may be located below the tightening portion, and include a surface with at least one tooth 324. In an embodiment of the invention, the at least one tooth 324 is an inclined tooth which further comprises an inclined surface and a leading edge. The teeth 324 of the bolt head 320 are configured to engage with the teeth 110 of the washer 100 in the manner described above, in reference to the teeth 220 of the nut 200.

The bolt, nut, and washer of the present invention may be formed of any materials used to form conventional bolts, nuts, and washers. The bolt, nut, and washer may be formed of a metal. For example, carbon steel is a common material used in fasteners, due to its strength and low cost. Carbon steel materials can include low carbon steels, medium carbon steels, and alloy steels. Other materials include stainless steel, steel, nickel alloys, aluminum, silicon bronze, copper, or brass. The bolt, nut, or washer may also be formed of non-metallic materials, such as thermoplastics, acetal, nylon, rubber materials, PEEK, high-density plastics, or wood. Further, when a permanent attachment by the fastening system of the present invention is not desired, the washer 100 may be formed of a material of a lesser strength (for instance, bronze, aluminum polymer, or plastics) such that the teeth 110 may shear off when a certain threshold amount of force is applied, as described above.

Similarly, in the fastening system of the present invention, the object 400 may be formed of any materials. In the case where the object 400 is formed of soft materials, such as wood or foam, the protrusions 120 may be formed with a longer length, or a wider width. In the case where the object 400 is formed of hard materials, such as cement or steel, the protrusions 120 may be formed with a shorter length, or a thinner width.

The embodiments described above provide a number of significant advantages. As discussed above, the fastening system prevents a nut from “backing off” of the shaft of a bolt. The fastening system of the present invention therefore increases the efficacy of the bolt over time, particularly in situations where the fastening system is likely to be subject to extreme conditions, loads or vibrations. Therefore, the fastening system is particularly useful in situations of high vibration, like in aeronautical, automotive, or rail applications, or in situations of extreme conditions, loads, or vibrations, like in weather-proofing outdoor structures.

Furthermore, the ratcheting interface of the fastening system of the present invention creates a mechanical connection that allows a holding torque that is greater than the torque applied while tightening, due to the interaction of the teeth 110 of the washer and the nut, as well as the protrusions 120 with the object 400. For example, a nut that is fastened at 20 pound-foot of torque can resist more than 60 pound-foot of resistance. In contrast, a conventional nut and bolt configuration, if tightened to 20 pound-foot torque, will only resist up to 20 pound-foot of torque before loosening.

Thus, it can be understood that a wide range of changes and modifications can be made to the preferred embodiment described above. It is therefore intended that the foregoing detailed description be understood that it is the following claims, including all equivalents, which are intended to define the scope of this invention.

1. A washer comprising:
a body having a first surface and a second surface; and
at least one protrusion extending from the first surface, wherein the at least one protrusion is configured to penetrate an object.

2. The washer of claim 1, further comprising a plurality of teeth located on the second surface.

3. The washer of claim 2, wherein the plurality of teeth are inclined teeth.

4. The washer of claim 3, wherein the plurality of inclined teeth have inclined surfaces and leading edges.

5. The washer of claim 1, wherein the at least one protrusion extends away from the washer in a direction substantially perpendicular to the washer.

6. A fastener comprising:
a washer with a first surface and a second surface, the first surface including at least one protrusion extending from the first surface, and the second surface including a first plurality of teeth; and
a washer engaging member having a second plurality of teeth configured to engage the first plurality of teeth of the washer.

7. The fastener of claim 6, further comprising a bolt, wherein the a washer is configured to slide along the bolt, and the washer engaging member is a nut is configured to engage with the bolt.

8. The fastener of claim 6, further comprising a bolt with a bolt head, wherein the bolt head is the washer engaging member.

9. The fastener of claim 7, wherein the bolt and nut are threaded.

10. The fastener of claim 6, wherein the at least one protrusion is configured to penetrate into a surface of at least one object.

11. The fastener of claim 6, wherein the at least one protrusion extends away from the washer in a direction substantially perpendicular to the washer.

12. The fastener of claim 6, wherein each of the first and second plurality of teeth are inclined teeth.

13. The fastener of claim 12, wherein the first plurality of inclined teeth are inverted from the second plurality of inclined teeth such that the first and second plurality of inclined teeth engage with substantially no gap between the washer and the washer engaging member.

14. The fastener of claim 12, wherein each of the first and second plurality of inclined teeth further comprise an inclined surface and a leading edge.

15. The fastener of claim 14, wherein when the nut is turned in a first direction relative to the washer, the leading edge of each of the second plurality of inclined teeth is located on a side of the tooth that leads in the first direction.

16. The fastener of claim 15, wherein when the washer engaging member is turned in a first direction relative to the washer, the inclined surfaces and leading edges are configured to allow the washer engaging member to turn while the plurality of protrusions penetrate into the surface of the at least one object.

17. The fastener of claim 16, wherein when the protrusions are penetrated into the surface of the at least one object, the leading edges of the first plurality of teeth prevent the washer engaging member from turning in a second direction relative to the washer.

18. The fastener of claim 12, wherein the first plurality of inclined teeth are configured to lock the washer engaging member in place.

19. The fastener of claim 9, wherein when the washer is slid along the bolt, and the nut is threaded along the bolt and turned in a first direction relative to the washer, the first and second plurality of teeth are configured to allow the nut to turn while the plurality of protrusions penetrate into the surface of the at least one object.

20. The fastener of claim 18, wherein when a threshold force is applied on the washer engaging member to turn the washer engaging member in a second direction relative to the washer, the first plurality of teeth of the washer are configured to shear off of the washer.
